(19) United States
(12) Patent Application Publication
(10) Pub. No.: US 2008/0276770 A1
(43) Pub. Date: Nov. 13, 2008

(54) Handle for a tool

(76) Inventors: Rainer Blum, Vorstetten (DE); Ernst von Lehmann, Monchweiler (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/151,707

(22) Filed: May 8, 2008

(30) Foreign Application Priority Data
May 12, 2007 (DE) 10 2007 022 291.4

(51) Int. Cl. B25G 1/00; B23P 17/00; B25B 15/00

(52) U.S. Cl. 81/489; 29/592; 81/436

(57) ABSTRACT

A handle for a tool, such as a screwdriver, has a handle core on which a handle sheath is situated. The handle core may be connectable or connected at a first end to a shaft of the tool. The handle sheath may have three areas in the longitudinal direction. A first area may adjoin the first end of the handle core and may include a semisoft zone, for example having a hardness of 60 to 80 Shore A. A second area, adjoining the first area, may include a soft zone, for example having a hardness of 10 to 60 Shore A. A third area, adjoining the second area, may be include a hard zone, for example having a hardness of greater than 90 Shore A.

### TECHNICAL FIELD

This application relates to tools and, more particularly, to a handle for a tool such as a screwdriver.

### BACKGROUND OF THE INVENTION

Handles for tools, in particular for screwdrivers, are known to have a handle core on which a handle sheath is situated. The handle core is connectable or connected at a first end to a shaft of the screwdriver. The handle sheaths of the handles for screwdrivers are known in various variations. In particular, producing the handle sheath from a soft plastic so that the handle lies better in the hand is known.

For example, a handle for a screwdriver is described in DE 10 2005 037 504 B3, which is incorporated herein by reference, in which chambers are provided in a handle sheath made of a soft plastic, which extend in a longitudinal direction of the handle to achieve especially good adaptation of the handle to the hand of a user.

Accordingly, it would be desirable to provide a tool and/or tool handle that adapts itself better to the hand of a user and is particularly suitable even for long-term usage, without pressure or friction points or even blisters arising in the area of the palm of the user.

### SUMMARY OF THE INVENTION

According to the system described herein, a handle for a tool has a handle sheath which may be divided into three areas in a longitudinal direction. The tool may be a screwdriver. The longitudinal direction may be defined by the longitudinal axis of the shaft of the tool. A first area of the handle sheath includes a semisoft zone. For example, the semisoft zone may have a hardness of 60 to 80 Shore A. A second area adjoins the first area, the second area including soft zone that has a hardness that is less than the semisoft zone of the first area. For example, the soft zone may have a hardness of 10 to 60 Shore A. A third area adjoins the second area and includes a hard zone having a hardness that is greater than the hardness of the semisoft zone of the first area. For example, the hard zone may have a hardness of greater than 90 Shore A.

The first area may face toward the shaft of the tool, in particular a screwdriver, and adjoins the first end of the handle core. The third area thus forms the terminus of the tool facing toward the user and offers the possibility, through the implementation as a hard zone, of also absorbing and relaying high pressure under certain circumstances, for example, by impacts when using a hammer. The second area which is implemented as a soft zone lies in the palm and thus adapts particularly well to the palm. The thumb and the index finger of the hand of the user come to rest in particular in the first area of the handle sheath. The first area, being implemented as a semisoft zone, forms a curling zone, so that torques may be transmitted particularly well from the hand of the user to the screwdriver. Because the first area is implemented as a slightly yielding area, the hand of the user is protected even during long-term use.

In various embodiments, the first area may be manufactured from a thermoplastic elastomer, in particular from styrene-ethylene-butylene-styrene (SEBS). This material in the desired hardness may offer the user special comfort and may also be processed particularly cost-effectively. The second area may be manufactured from a thermoplastic elastomer or a foamed material, in particular from polyurethane foam. A foamed material has the advantage in relation to injection-molded material that upon load by pressure of the palm, for example, the volume of the material may be changed and thus a particularly favorable adaptation of the material to the palm results. The third area may be manufactured entirely from steel or, alternatively, may be made of another material and have an insert made of steel. For example, the third area may be manufactured from a hard plastic with a steel insert and thus obtain a greater stability. In particular, higher impulses may be transmitted to the shaft by the steel insert. The third area may thus include the desired hardness and may additionally be manufactured particularly easily and cost-effectively.

The first area may have an external surface which widens symmetrically in the direction toward the shaft. A slipping zone is thus formed, which prevents the finger or hand of the user from slipping off in the direction toward the shaft when exerting pressure to tighten a screw. The second area may have an external surface which bulges symmetrically outward. A particularly ergonomic handle shape may thus achieved. The three areas may be situated directly and nonremovably on the handle core. In an alternative embodiment, however, at least one of the areas may be replaceable, so that the handle may be adapted easily to various requirements.

The shaft may be situated in one piece on the handle core. Alternatively, the shaft may be situated replaceably on the handle core, to allow greater flexibility of the handle. A symbol for the working end may be situated in the front face of the third area, so that it may be easily recognized which type of screwdriver is provided. The symbol may be situated behind a viewing window, and provide a smooth external surface of the handle.

According further to the system described herein, a method of manufacturing a handle for a tool includes providing a handle sheath disposed on a handle core. Three areas are provided in the handle sheath in a longitudinal direction, the three areas including a first area, a second area and a third area. The first area includes a semisoft zone having a first hardness, wherein the first area adjoins the first end of the handle core. The second area adjoins the first area and includes a soft zone having a second hardness that is less than the first hardness. The third area adjoins the second area, and includes a hard zone having a third hardness, the third hardness being greater than the first hardness. At least one of: the first area, the second area and the third area may be replaceable. The method may further include inserting an insert into the third area.

According further to the system described herein, a tool includes a working tool end and a handle coupled to the working tool end. The handle includes a handle core and a handle sheath disposed on the handle core. The handle core may be coupled at a first end to a shaft of the working tool end, and wherein the handle sheath has three areas in a longitudinal direction, the three areas including a first area, a second area and a third area. The first area may include a semisoft zone having a first hardness, and the first area may adjoin the first end of the handle core. The second area may adjoin the first area, the second area including a soft zone having a second hardness that is less than the first hardness. The third area may adjoin the second area, the third area including a hard zone having a third hardness, the third hardness being greater than the first hardness of the semisoft zone. The working tool end may be a screwdriver end.

### BRIEF DESCRIPTION OF THE DRAWINGS

Embodiments of the system described herein are explained in greater detail on the basis of the figures of the drawings, briefly described as follows.

FIG. 1 shows a perspective view of a screwdriver according to an embodiment of the system described herein.

FIG. 2 shows an exploded illustration of the screwdriver from FIG. 1.

FIG. 3 shows a partially exploded illustration of the screwdriver from FIG. 1.

FIG. 4 shows an enlarged three-dimensional illustration of a part of the handle of the screwdriver from FIG. 1 having a partially cutaway view.

FIG. 5 shows a perspective illustration of a part of a handle of a screwdriver according to another embodiment of the system described herein having a partially cutaway view.

### DETAILED DESCRIPTION OF VARIOUS EMBODIMENTS

Referring now to the figures of the drawing, the figures comprise a part of this specification and illustrate exemplary embodiments of the described system. It is to be understood that in some instances various aspects of the system may be shown schematically or may be shown exaggerated or altered to facilitate an understanding of the system.

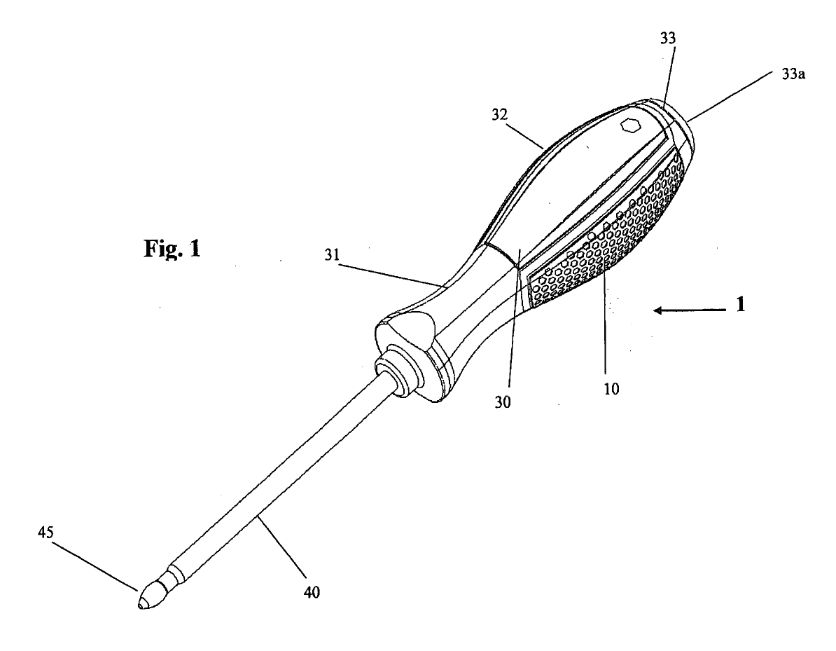

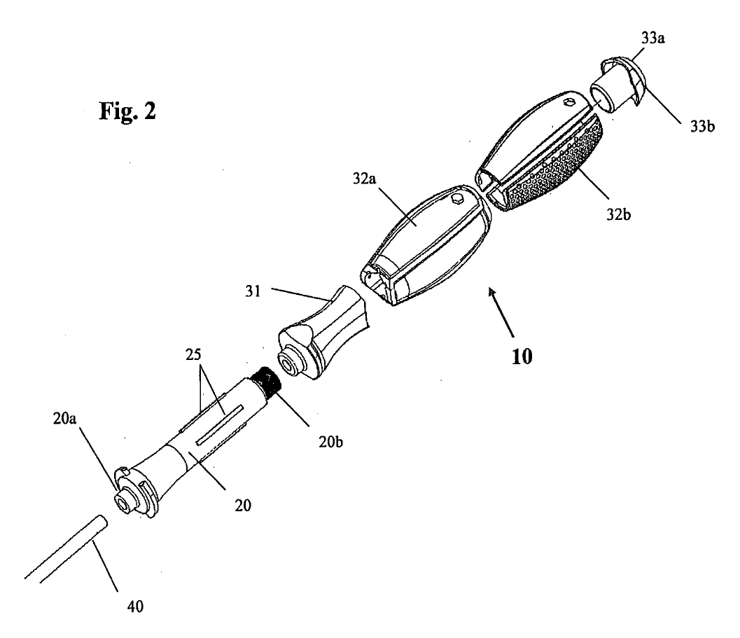

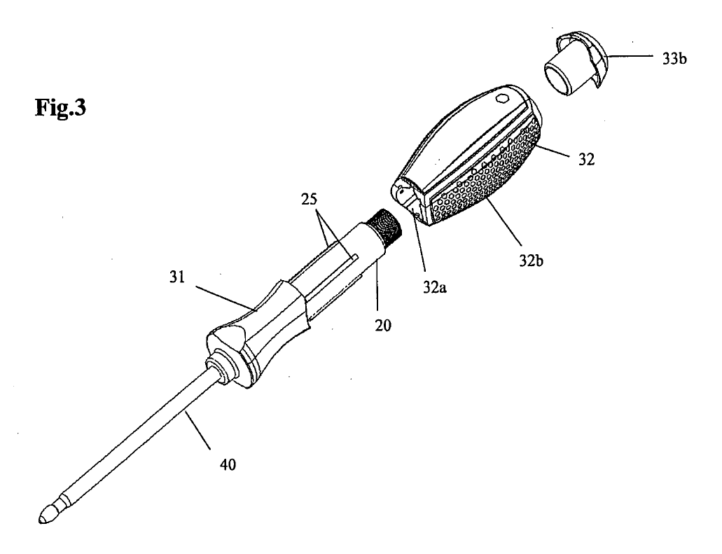

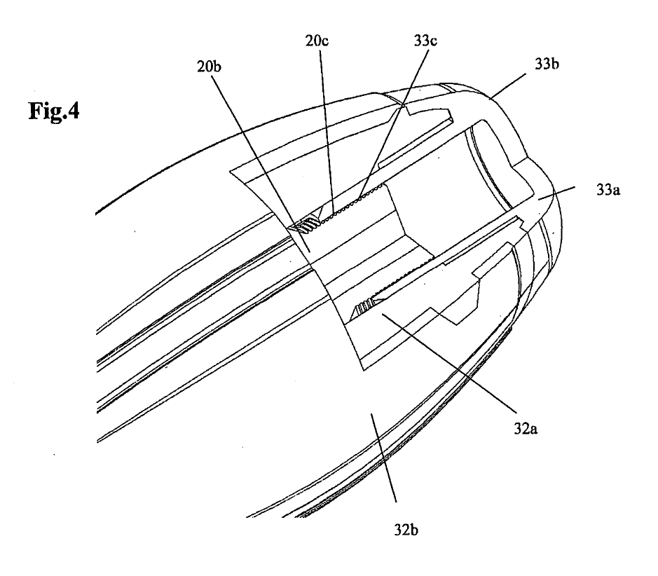

FIGS. 1 through 4 show various illustrations a screwdriver 1 according to an embodiment of the system described herein. FIG. 1 shows a perspective view of the screwdriver 1. FIG. 2 shows an exploded illustration of the screwdriver 1. FIG. 3 shows a partially exploded illustration of the screwdriver 1. FIG. 4 shows an enlarged three-dimensional illustration of a part of the handle of the screwdriver 1 with a partially cutaway view. The screwdriver 1 has a handle 10, on which a shaft 40 is situated. The handle 10 has, as shown in FIG. 2 in particular, a handle core 20 which may be enclosed by a handle sheath 30. The handle core 20 may have a first end 20a and a second end 20b, the shaft 40 being situated on the first end 20a. The longitudinal axis of the shaft 40 may correspond to the longitudinal axis of the handle core 20. The handle core 20 may be connected in one piece to the shaft 40. Alternatively, the shaft 40 may also be situated replaceably on the handle core 20. The end of shaft 40 facing away from the handle 10 may have a working end 45, which may be a tool. For example, a flathead screwdriver, a Phillips screwdriver, or a similar tool may be situated on the shaft 40 as the working end 45.

The handle sheath 30 may have a first area 31, a second area 32, and a third area 33 in the longitudinal direction of handle 10. The first area 31 may be in the area of the first end 20a of the handle core 20 and thus form the end of the handle 10 facing toward shaft 40. The second area 32 adjoins the first area 31. The third area 33 adjoins the second end 20b of the handle core 20 and forms the front end of the handle 10, which faces toward the user.

The first area 31 may be implemented as a semisoft zone. In an embodiment, the first area 31 may have a hardness of 60 to 80 Shore A. The first area 31 may be manufactured from a thermoplastic elastomer, in particular styrene-ethylene-butylene-styrene (SEBS), and may be extrusion coated directly on the handle core 20, for example. The first area 31 may have an external surface which expands symmetrically in the direction toward shaft 40. A slip protection may thus be achieved, which prevents the finger of the hand of the user from slipping off in the direction toward shaft 40 when screwdriver 1 is used.

The second area 32 adjoins the first area 31 and may be implemented as a soft zone having a hardness that is less than that of the semisoft zone of the first area 31. In an embodiment, the soft zone of the second area 32 may have a hardness of 10 to 60 Shore A. The second area 32 may be manufactured in particular from a foamed material of the desired hardness, for example, from polyurethane foam. The foamed material may also be applied directly to the handle core 20. In the illustrated exemplary embodiment, however, the second area 32 may have a main body 32a, which has an substantially hollow cylindrical design and may be pushed onto the handle core 20. A sleeve 32b made of a desired material and foamed onto the outside of main body 32a. The foamed material may rest against the palm of a user especially well. In an embodiment, it is possible to appropriately deform the foamed material by pressure, by which an ideal matching shape may result. The second area 32 may have an external surface which bulges outward and thus forms a particularly ergonomic handle shape. The handle core 20 may have longitudinal ribs 35 which engage in main body 32a and form an anti-twist device in the area in which the second area 32 is situated.

The third area 33 adjoins the second area 32 and may be formed by a cap 33b. The cap 33b thus forms the end of the handle 10 facing toward the user, a part of the external surface of cap 33b forming a front face 33a. The cap 33b may include a hard zone having a hardness greater than the hardness of the semisoft zone of the first area 31. For example, the hard zone of the third area 33 may have a hardness greater than 90 Shore A. The cap 33b may be manufactured from a hard plastic, such as polypropylene and/or cellulose acetate, and/or from steel. The second end 20b of the handle core 20 has teeth 20c which may engage in teeth 33c of the cap 33b, so that the cap 33b is fixed securely on the handle core 20. The cap 33b may also be fastened to the handle core 20 via other fastening means such as a catch mechanism, a thread, and/or similar means.

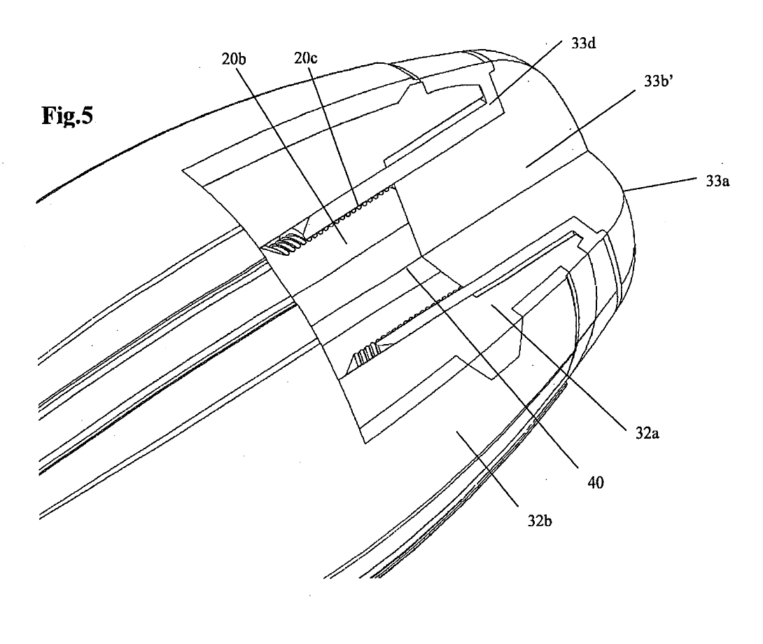

FIG. 5 is a schematic illustration of an alternative implementation of a cap 33b′, which may correspond to the external dimensions of cap 33b according to the exemplary embodiment shown in FIG. 4. However, the cap 33b′ may not be may completely manufactured from one material, but may instead have a steel insert 33d, which forms the fastener to the handle core 20. The part of the cap 33b′ forming front face 33a may be manufactured from a hard plastic such as polypropylene or cellulose acetate, for example. In another embodiment, a viewing window may be embedded in front face 33a of caps 33b, 33b′, behind which a symbol is situated, which corresponds to the working end 45 of shaft 40. The type of screwdriver 1 which is being used may thus be directly visible.

In the embodiments discussed herein, the first area 31 may be connected fixedly to the handle core 20. The second area 32 and the third area 33 may be situated replaceably on the handle core 20. It is thus possible to adapt the screwdriver 1 to various requirements. It is also possible to assemble the handle 10 of the screwdriver 1 modularly from the first area 31, the second area 32, and the third area 33, but to subsequently no longer allow replacement of areas 31, 32, 33.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A handle for a tool, comprising:
a handle core; and
a handle sheath disposed on the handle core, wherein the handle core is connectable at a first end to a shaft of the tool, and wherein the handle sheath has three areas in a longitudinal direction, the three areas including:
a first area including a semisoft zone having a first hardness, wherein the first area adjoins the first end of the handle core;
a second area adjoining the first area, the second area including a soft zone having a second hardness that is less than the first hardness of the semisoft zone; and
a third area adjoining the second area, the third area including a hard zone having a third hardness, the third hardness being greater than the first hardness of the semisoft zone.

2. The handle as recited in claim 1, wherein the first area is manufactured from a thermoplastic elastomer.

3. The handle as recited in claim 2, wherein the thermoplastic elastomer is styrene-ethylene-butylene-styrene.

4. The handle as recited in claim 1, wherein the second area is manufactured from at least one of: a thermoplastic elastomer and a foamed material.

5. The handle as recited in claim 4, wherein the foamed material is polyurethane foam.

6. The handle as recited in claim 1, wherein the third area is manufactured from at least one of: plastic and steel.

7. The handle as recited in claim 1, wherein third area includes an insert made of steel.

8. The handle as recited in claim 1, wherein the first area has an external surface which widens symmetrically in a direction toward the shaft.

9. The handle as recited in claim 1, wherein the second area has an external surface which bulges outward.

10. The handle as recited in claim 1, wherein at least one of: the first area, the second area and the third area are replaceable.

11. The handle as recited in claim 1, wherein the shaft is replaceably situated on the handle core.

12. The handle as recited in claim 1, further comprising:
a symbol for a working end of the tool is disposed in a front face of the third area.

13. The handles as recited in claim 12, wherein the symbol is behind a viewing window disposed in the front face of the third area.

14. The handle as recited in claim 1, wherein the first hardness of the semisoft zone is 60 to 80 Shore A, the second hardness of the soft zone is 10 to 60 Shore A, and the third hardness of the hard zone is greater than 90 Shore A.

15. The handle as recited in claim 1, wherein the tool is a screwdriver.

16. A method of manufacturing a handle for a tool, comprising:
providing a handle sheath disposed on a handle core; and
providing three areas in the handle sheath in a longitudinal direction, the three areas including:
a first area including a semisoft zone having a first hardness, wherein the first area adjoins the first end of the handle core;
a second area adjoining the first area, the second area including a soft zone having a second hardness that is less than the first hardness; and
a third area adjoining the second area, the third area including a hard zone having a third hardness, the third hardness being greater than the first hardness.

17. The method as recited in claim 16, wherein at least one of: the first area, the second area and the third area are replaceable.

18. The method as recited in claim 16, further comprising:
inserting an insert into the third area.

19. A tool, comprising:
a working tool end; and
a handle coupled to the working tool end, the handle including:
a handle core; and
a handle sheath disposed on the handle core, wherein the handle core is coupled at a first end to a shaft of the working tool end, and wherein the handle sheath has three areas in a longitudinal direction, the three areas including:
a first area including a semisoft zone having a first hardness, wherein the first area adjoins the first end of the handle core;
a second area adjoining the first area, the second area including a soft zone having a second hardness that is less than the first hardness of the semisoft zone; and
a third area adjoining the second area, the third area including a hard zone having a third hardness, the third hardness being greater than the first hardness of the semisoft zone.

20. The tool as recited in claim 19, wherein the working tool end is a screwdriver end.
